(19) United States
(12) Patent Application Publication
(10) Pub. No.: US 2013/0302465 A1
(43) Pub. Date: Nov. 14, 2013

(54) MOLD WITH DETACHABLE GUIDE POSTS

(71) Applicant: JIA-MING WANG, Tu-Cheng (TW)

(72) Inventor: JIA-MING WANG, Tu-Cheng (TW)

(21) Appl. No.: 13/660,013

(22) Filed: Oct. 25, 2012

(30) Foreign Application Priority Data
May 14, 2012 (TW) 101117066

(51) Int. Cl. B29C 45/26

(52) U.S. Cl. 425/470

(57) ABSTRACT

A mold includes a mold base, a number of guide post fixing blocks, and a number of guide posts. The mold base includes a separating surface, and a number of cutouts formed in the separating surface. The guide post fixing blocks are positioned in the respective cutouts. Each of the guide post fixing blocks includes a main body having a through hole, and a step hole located at a lower end of the through hole and in communication with the through hole, with a diameter of the step hole being greater than that of the through hole. The guide posts each includes a guide portion and a flange extending from a bottom of the guide portion, the flange engaged in the step hole and the guide portion extending through the through hole. The guide post fixing blocks are fixed in the cutouts by screws.

### BACKGROUND

1. Technical Field

The present disclosure relates to molds, and particularly to a mold with detachable guide posts.

2. Description of Related Art

Guide posts are key components of molds. In a typical mold, a number of guide posts extend from a bottom of the mold, and in an injection molding machine, the mold is to match with another mold having a number of guide holes.

However, with the above configuration, if an amendment or an adjustment of the guide posts is needed, then the mold must be taken off from the injection molding machine, and the guide posts must be demounted from the bottom of the mold.

What is needed, therefore, is a mold with detachable guide posts, which can overcome the above shortcomings.

### BRIEF DESCRIPTION OF THE DRAWINGS

Many aspects of the present mold with detachable guide posts can be better understood with reference to the following drawings. The components in the drawings are not necessarily drawn to scale, the emphasis instead being placed upon clearly illustrating the principles of the present mold with detachable guide posts. Moreover, in the drawings, like reference numerals designate corresponding parts throughout the several views.

FIG. 1 is schematic isometric view of a mold in accordance with an embodiment.

FIG. 2 is a disassembled view of the mold of FIG. 1

FIG. 3 is similar to FIG. 2, but viewing from an opposite direction.

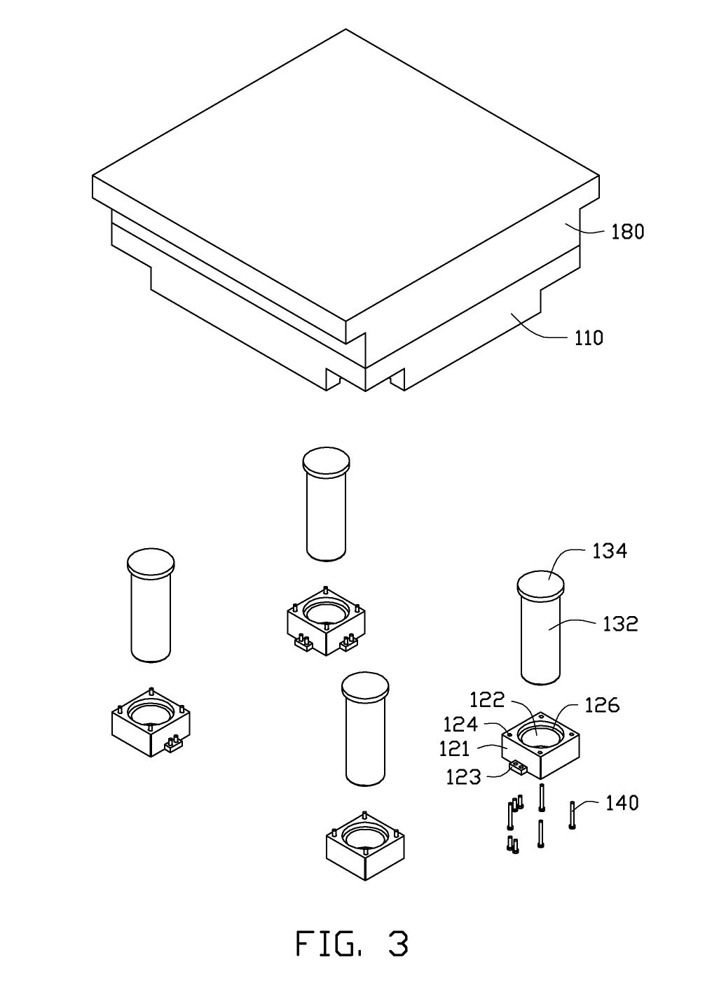

FIG. 4 shows exemplary another mold in cooperation with the mold of FIG. 1 in application.

### DETAILED DESCRIPTION

Embodiments of the present mold with detachable guide posts will now be described in detail below and with reference to the drawings.

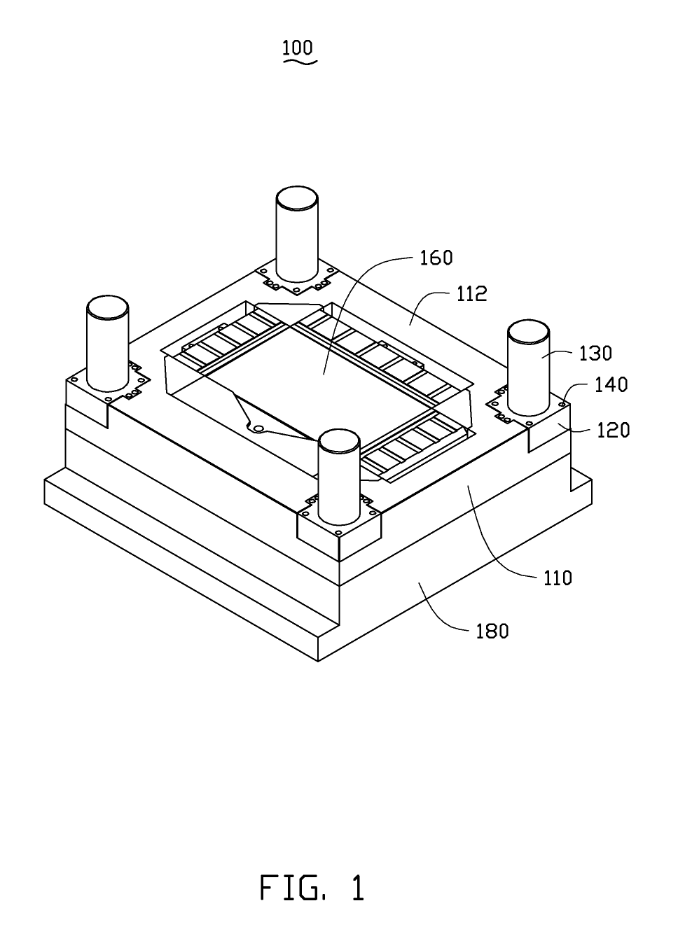

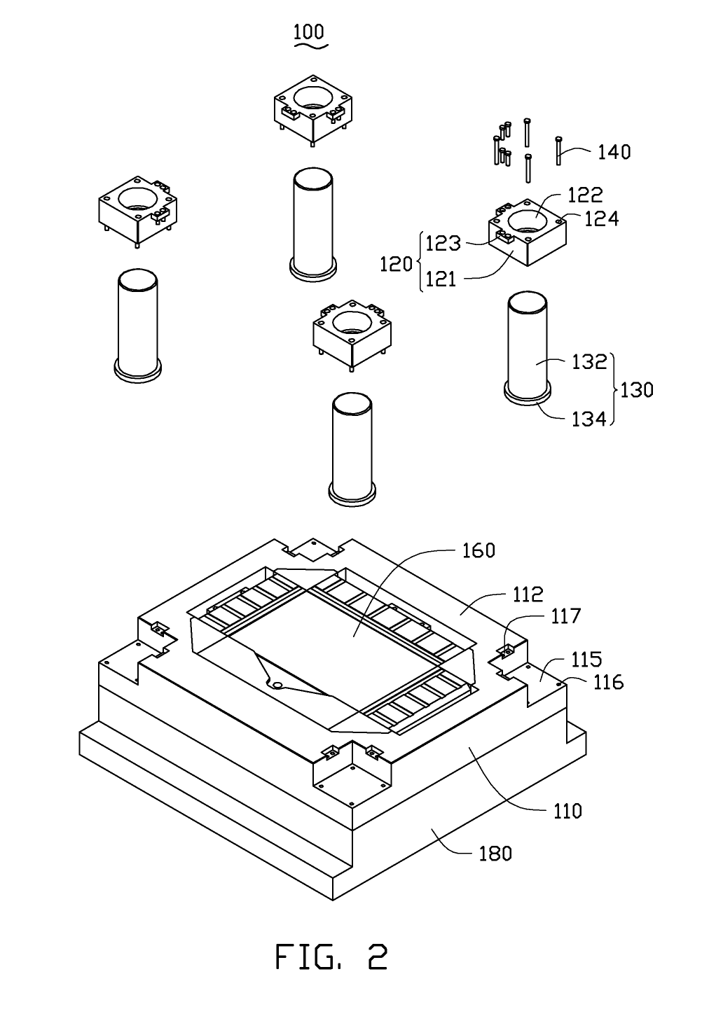

Referring to FIGS. 1 to 2, a mold 100 in accordance with an embodiment is shown. The mold 100 includes a mold base 110, a plurality of guide post fixing blocks 120, a plurality of guide posts 130 and a plurality of screws 140. In an injection molding, the mold 100 is only a mold part, and the mold 100 can be used as a male mold part, which has to be in cooperation with a female mold part.

The mold base 110 has a separating surface 112 having four corners, and each corner of the separating surface 112 has a cutout 115. Each of the cutouts 115 is exposed to two sides of the mold base 110, and each of the remaining two sides of each of the cutouts 115 defines a recess 117. A plurality of screw engaging holes 116 are formed in each of the cutouts 115, and as well as in each of the recesses 117.

Each of the guide post fixing blocks 120 includes a main body 121 and two ear portions 123 extending from two adjacent sides of the main body 121. The ear portions 123 are perpendicular to the corresponding sides of the main body 121. The main body 121 has a through hole 122 and a step hole 126 formed in a center of the main body 121. The step hole 126 is in communication with the through hole 122, and the step hole 126 is located at a lower end of the main body 121. The step hole 126 is greater than the through hole 122. Each of the main body 121 and the ear portions 123 has a number of screws through holes 124.

Each of the guide posts 130 includes a guide portion 132 and a flange 134 extending outwards from a bottom of the guide portion 132.

In application, the guide posts 130 extend through the respective through holes 122 of the guide post fixing blocks 120, with the flange 134 engaged in the step holes 126. The package of the guide post fixing blocks 120 and the guide posts 130 is then disposed on the cutout 115, with the ear portions 123 engaged in the recesses 117. Then, the screws 140 engage in the respective screw through holes 124 and screw engaging holes 116 to fasten the guide post fixing blocks 120 and the guide posts 130 in position.

A mold core can be mounted in the mold base 110, and a molding surface 160 can be formed on the mold core. In an injection molding, the mold base 110 can be connected to a mold plate 180.

The guide posts 130 are fastened on mold base 110, in such a way that the guide posts 130 can be detached from the mold 100 easily, and in mounting and demounting of the guide posts 130, the mold 100 does not need to be demounted from the injection molding machine.

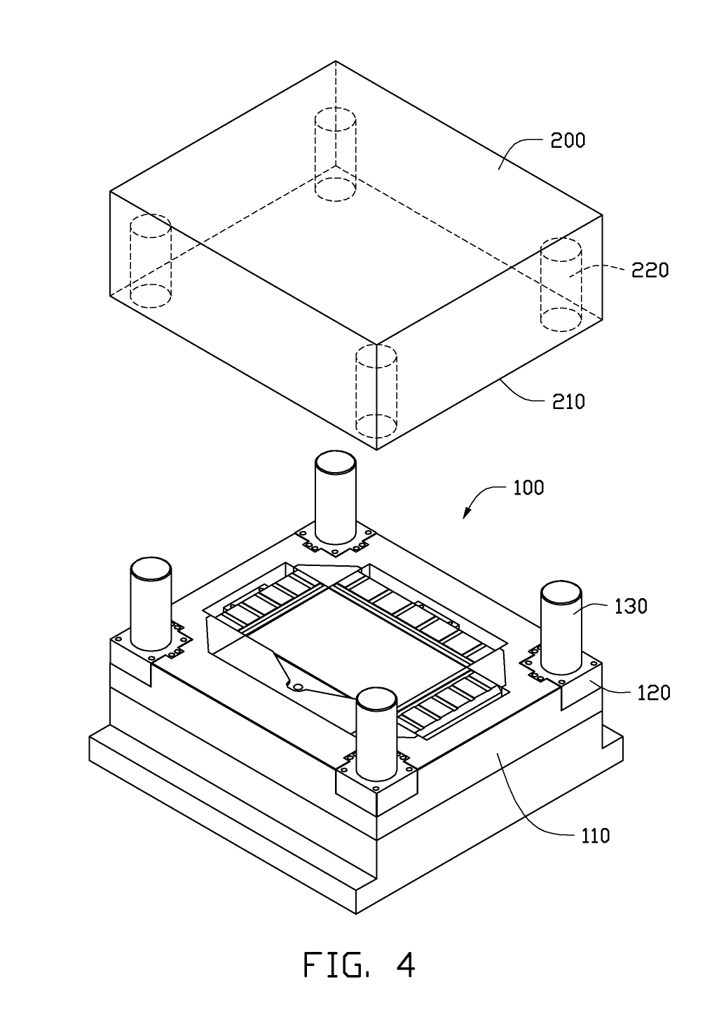

Referring to FIG. 4, in injection molding, the mold 100 cooperates with another mold 200. The mold 200 also has a separating surface 210, and a plurality of guide holes 220 are formed in the separating surface 210. The guide posts 130 are to be engaged in the guide holes 220, such that the mold 100 is matched with the mold 200.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A mold comprising:
a mold base comprising a separating surface, a plurality of cutouts defined in the separating surface, and a plurality of screw engaging holes formed at the cutouts;
a plurality of guide post fixing blocks positioned in the respective cutouts, each of the guide post fixing blocks comprising a main body having a through hole, a step hole located at a lower end of the through hole and in communication with the through hole, and plurality of screw through holes surrounding the through hole, a diameter of the step hole being greater than that of the through hole;
a plurality of guide posts each comprising a guide portion and a flange formed on a lower end of the guide portion, the flange engaged in the step hole and the guide portion extending through the through hole; and
a plurality of screws engaged in the screw engaging holes and the screw through holes to fix the guide post fixing blocks in the cutouts.

2. The mold of claim 1, wherein the cutouts are arranged at respective corners of the separating surface, and each cutout is exposed at two adjacent sides of the mold base.

3. The mold of claim 2, wherein the mold base further comprises two recesses are defined in the separating surface adjacent to each cutout, the recesses communicating with the corresponding cutout, the guide post fixing blocks further comprises two ear portions extending from two adjacent sides of the main body, the ear portions engaged in the respective recesses.

4. The mold of claim 3, wherein the mold base further comprises a plurality of screw engaging holes formed in the recesses, and each of the ear portions comprises a plurality of screw through holes, the mold further comprises a plurality of screws engaged in the screw engaging holes and the screw through holes to fix the ear portions in the recesses.

5. The mold of claim 3, wherein the ear portions are respectively perpendicular to the adjacent sides of the main body.

6. The mold of claim 1, wherein the through hole and the step hole are located in a center of the main body of the guide post fixing block.

7. A mold comprising:
a first mold part comprising:
a mold base comprising a first separating surface, a plurality of cutouts defined in the separating surface, and a plurality of screw engaging holes formed in the cutouts;
a plurality of guide post fixing blocks positioned in the respective cutouts, each of the guide post fixing blocks comprising a main body having a through hole, a step hole located at a lower end of the through hole and in communication with the through hole, and plurality of screw through holes surrounding the through hole, a diameter of the step hole being greater than that of the through hole;
a plurality of guide posts each comprising a guide portion and a flange formed at a lower end of the guide portion, the flange engaged in the step hole and the guide portion extending through the through hole; and
a plurality of screws engaged in the screw engaging holes and the screw through holes to fix the guide post fixing blocks in the cutouts; and
a second mold part comprising a second separating surface and a plurality of guide holes formed in the second separating surface, the guide posts being engageable in the respective guide holes.
